(19) United States
(12) Patent Application Publication
(10) Pub. No.: US 2025/0170775 A1
(43) Pub. Date: May 29, 2025

(54) BUILD MATERIAL POWER DRUM

(71) Applicant: Desktop Metal, Inc., Burlington, MA (US)

(72) Inventors: Peter ZUMMO, Burlington, MA (US); Eric WALKAMA, Burlington, MA (US); Robert DOWNING, Burlington, MA (US); George HUDELSON, Burlington, MA (US)

(21) Appl. No.: 18/840,089

(22) PCT Filed: Feb. 15, 2023
(86) PCT No.: PCT/US2023/013080

§ 371 Date: Aug. 21, 2024

Related U.S. Application Data
(60) Provisional application No. 63/312,283, filed on Feb. 21, 2022.

(51) Int. Cl. B29C 64/255; B22F 10/14; B22F 12/00; B29C 64/165; B33Y 40/00

(52) U.S. Cl. CPC B29C 64/255; B22F 12/38; B33Y 40/00; B22F 10/14; B29C 64/165

(57) ABSTRACT

A drum for storing and processing build material powder includes a cylindrical body having a plurality of circumferential rings and a plurality of internal baffles. The first end of the cylindrical body is sealed by a first cap that is tapered to an orifice. The second end of the cylindrical body is sealed by a second cap. A gas inlet configured to receive an inflow of an inert gas and a gas outlet configured to exhaust used gas from an interior of the drum.

### RELATED APPLICATIONS

This application is a US National Stage Application, filed under 35 U.S.C. § 371, of International Application PCT/US2023/013080, filed on Feb. 15, 2023 and claims priority to U.S. Patent Application 63/312,283, filed on Feb. 21, 2022; the contents of the above applications are incorporated by reference herein in their entirety.

### TECHNICAL FIELD

Various aspects of the present disclosure relate to a drum for containing and curing build material powder used in binder jetting additive manufacturing.

### BACKGROUND OF THE DISCLOSURE

Binder jetting is an additive manufacturing technique by which a thin layer of powder (e.g. 65 μm) is spread onto a bed, followed by deposition of a liquid binder in a 2D pattern or image that represents a single “slice” of a 3D shape. After deposition of binder, another layer of powder is spread, and the process is repeated to form a 3D volume of bound material within the powder bed. After printing, the bound part may be, in reversible order, cured or crosslinked to strengthen the binder, and removed from the excess build material powder.

Build material powder used in binder jetting presents numerous challenges. Build material powder that is new or that has been recycled several times may require curing prior to use. Further, certain materials in powder form represent an explosion and/or health hazard. At various stages, it is also beneficial to control the atmospheric conditions to which the build material powder is subjected, for instance by subjecting it to the presence of a process gas or vacuum, or to remove moisture or other undesirable contaminants. In many existing systems build material powder must be variously passed through various containers and manually processed through systems exposed to ambient air. In such setups it is also difficult to track amounts of build material powder between various stages of processing use and also prevent cross-contamination or use of incorrect materials.

### SUMMARY

Disclosed is a single drum for storing, sealing, processing and using build material powder for use in binder jetting additive manufacture of parts that facilitates efficient processing and use, while promoting easy tracking and identification. The drum includes a body containing internal baffles providing structural support and circumferential rings on an exterior that may be used to rotate the drum using a set of casters. One end of the drum is tapered to facilitate gravity feeding of build material powder. The drum may also have gas inputs and outputs for providing process gas, extracting used gas or applying vacuum to the interior of the drum when it is sealed at an orifice of the tapered end. An interface on a second side of the drum may be configured to aid in rotation of the drum along a longitudinal axis.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a component schematic diagram of a binder jetting printer for use with embodiments of the present disclosure.

FIG. 2 depicts a cutaway view of the binder jetting printer of FIG. 1.

FIGS. 3A-D depict a drum according to at least one exemplary embodiment of the present disclosure.

FIG. 4 depicts a rotation plate according to at least one exemplary embodiment of the present disclosure.

FIG. 5 depicts a gas port according to at least one exemplary embodiment of the present disclosure.

FIG. 6 depicts a second drum according to at least one exemplary embodiment of the present disclosure.

FIG. 7 depicts a rotation mechanism according to at least one exemplary embodiment of the present disclosure.

### DETAILED DESCRIPTION

A description of binder jetting is now provided for context for understanding the use of the disclosed drum.

In certain embodiments, a binder jet printer may comprise a print enclosure with a number of modules configured to aid in or accomplish the additive manufacturing of parts and other objects from a build material powder. These modules may include: (1) an assemblage of printheads (or one printhead in certain embodiments), (2) an ink delivery system to supply the printheads with binder at flow and pressure conditions necessary for stable binder ejection from the printhead, (3) a build material supply module to deliver an amount of build material powder to a print surface (also known as a work surface or a build surface) within the printer, (4) a build material spreading module to spread an amount of build material powder which has been supplied to a print surface (or work surface, or build surface) to a controlled thickness, (5) a container and indexing motion system to contain the build material powder and during printing move the container to specific positions (e.g., by moving in a first direction relative to a least one of the modules (1)-(4)) to enable the fabrication of successive layers of an object. In some embodiments, the printer may comprise additional modules including: (6) devices configured to reduce, prevent, or remove build material powder and/or ejecta from the printhead that may become suspended in an atmosphere in the print enclosure, including, according to certain embodiments, devices which deposit liquids (e.g., water, alcohol, oils, and the like) onto a surface of the build material powder to alter the cohesive characteristics of the powder, devices which control and/or provide a flow of gas to remove and/or filter suspended ejecta, (7) devices configured to control the gaseous atmosphere within the print enclosure relative to a gaseous atmosphere surrounding the binder jet printer, and (8) at least one reciprocating mechanism to provide relative motion between the container containing build material powder and at least one of the modules (1) to (4) in a second direction different from the first direction of the container and indexing system.

Build material powders may be sensitive to certain gaseous atmospheres. According to certain embodiments, it is desirable to prevent, minimize, or otherwise avoid gaseous communication between certain gaseous species and specific metal powders. For example, a copper build material powder may oxidize when in contact with air. In certain embodiments of the binder jetting printing process, such an oxidation of copper may be deleterious to the printing process for at least the reason that the oxidation may be uncontrolled and may introduce uncertainty into certain aspects of the binder jet printing process. In certain embodiments, a build material powder may be reactive (e.g, pyrophoric or explosible) with moisture and the build material powder should be kept separate from a base level of moisture contained in ambient air (e.g., room humidity). In certain embodiments, a build material powder may not be chemically sensitive (e.g., prone to oxidation, explosibility, pyrophoricity, or other means of chemical reaction) but may exhibit a change in physical properties such as the ability of the build material powder to flow. In the case where the flow characteristics of the powder will vary, degrade, or otherwise change, maintaining a consistent atmosphere around the build material powder may be required.

In another embodiment, build material powders may be reactive (e.g. pyrophoric or explosible) in the presence of oxygen and ignition sources capable of providing energy above the minimum ignition energy or temperatures above the minimum ignition temperature of the powder. Certain of the process modules (1) to (8) may provide sufficient energy or temperature to exceed these ignition limits, creating a condition in which a reaction may occur. In such cases, it may be desirable to maintain the printing environment in an inerted state, with the oxygen concentration of the atmosphere maintained below a predetermined concentration which is lower than the limiting oxygen concentration, or the concentration below which combustion of the build material powder does not readily occur. A typical target oxygen concentration may be 2%, which is below a typical limiting oxygen concentration of 4-185% for commonly printed materials.

In the process of binder jet additive manufacturing, a build material powder is typically supplied to a binder jet printer and some amount of this build material powder is bound using a binder to form objects. These objects are provided with various names in the field of art, and may be referred to as green parts, but are sometimes also referred to as brown parts. In certain embodiments, the objects formed may include parts that, as one skilled in the art will appreciate, may undergo subsequent post-processing steps (perhaps including a curing, drying, or crosslinking step) to improve the mechanical properties (such as strength, fracture toughness, elongation to failure, and the like) of the bound object.

### Post-Processing

In certain embodiments, post-processing (such as curing, drying, crosslinking, and the like) may be optionally performed to improve the mechanical properties of objects fabricated from build material powder and binder. In certain embodiments, the improvement of mechanical properties attained during the post-processing steps may reduce breakages of objects that can occur during the removal of unbound build material powder from the surfaces of the objects formed from binder and build material powder. This process of removing unbound build material powder (that is, powder which is not held or adhered to an object with binder) is often termed “depowdering”. As one skilled in the art may appreciate, several approaches may be pursued to depowder parts.

### Objects: Parts and Supports

Several types of objects may be printed using a binder jet printer. In certain embodiments, a single object may comprise a single part. In certain embodiments, a single object may comprise a series of parts connected with a mechanical linkage permitting relative motion (such as a hinge, slide, or other element). In certain embodiments, a single object may comprise a series of parts connected with a mechanical linkage in which motion is prohibited, substantially prohibited, or the parts are otherwise fully constrained in all directions of translation and rotation. In certain embodiments, a single object may comprise a series of parts connected with at least one mechanical linkage permitting motion in at least one direction, and prohibiting motion in at least one other direction (such as, for example, in a sliding mechanism permitting motion in a first sliding direction with constraint imposed in a second constraining direction orthogonal to the first direction). In certain embodiments, a single object may comprise a part and a supporting structure, where the supporting structure may be configured to touch, abut, hold, cradle, or otherwise contact the part at or through at least one point across opposed surfaces of the part and support structure. In certain embodiments, the support structure may provide a means of support to the part. In certain embodiments, the means of support may be mechanical, such that the support structure, through the at least one point, carries a stress or force transmitted through or imposed upon the part. In certain embodiments, the part and the support may be printed in a first configuration and brought to contact in a second configuration, where the second configuration enables the support structure to provide support to the part.

### Thermal Processing

Following binder jet printing and optional post-processing of the object, the object may be further subjected to thermal processing, according to certain embodiments. The thermal processing may include the steps of debinding and sintering of the object.

### Debinding

During debinding, binder is removed from the object. Debinding may be performed in any suitable chamber or enclosure. In certain embodiments, a suitable chamber or enclosure may include a means of heating the object, a means of providing a flow of process gas, a means of evacuating a process gas, and a means of controlling a pressure of the process gas, as will be appreciated by one skilled in the art.

Not being bound by theory, debinding may remove binder by a thermally activated process of evaporation, sublimation, combustion, oxidation, or degradation, according to certain embodiments. Depending upon the specific binder and build material powder materials in the object undergoing debinding, the debinding process may be tailored to achieve the desired amount of debinding.

In certain embodiments, the debinding process may begin at any temperature from the list of starting debinding temperatures: 200, 250, 300, 350, 400, or 450 degrees centigrade. In certain embodiments, the debinding process may end at any temperature from the list of ending debinding temperatures: 250, 300, 350, 400, 500, or 600 degrees centigrade. For example, a debind process may occur between 200 and 350 degrees centigrade, or may occur between 300 and 600 degrees centigrade. It should be understood by one skilled in the art that the starting debinding temperature will be less than the ending debinding temperature.

The debinding process may require the maintenance of a specific gaseous atmosphere surrounding the objects, according to certain embodiments. The gaseous atmosphere may include the gases argon, nitrogen, oxygen, hydrogen, helium, carbon dioxide, carbon monoxide, ammonia, methane, air, or the like. According to certain embodiments, the gaseous atmosphere may be a mixture of gases. According to certain embodiments, the gaseous atmosphere may be substantially absent and a vacuum may exist about the parts. According to certain embodiments, a gaseous atmosphere may be provided by a process gas.

The debinding process may require, or more optimally perform with a specific pressure or range of pressures of a process gas. According to certain embodiments, the pressure of the gaseous atmosphere during debinding may be equal to or may exceed 1 atmosphere. According to certain embodiments, the pressure of the gaseous atmosphere during debinding may be between 0.5 and 1 atmosphere. According to certain embodiments, the pressure of the gaseous atmosphere may be between 0.01 and 0.5 atmospheres. According to certain embodiments, the pressure of the gaseous atmosphere may be between 0.01 and 10 Torr. According to certain embodiments, the pressure of the gaseous atmosphere may be less than 0.01 Torr. In certain embodiments, a desired pressure may be maintained with a vacuum pump and a supply of process gas, where the volume of gas removed by the pump and the supply of process gas at least partially determine the pressure within the debind chamber.

### Sintering

Following the removal of at least a portion of the binder by the debinding process, the object may then be sintered, according to certain embodiments. In certain embodiments, the objects may be sintered without the removal of the binder, or without the binder removal step.

Not being bound by theory, during the process of sintering, the build material powder is heated to result in the joining of the build material powders to form a sintered object. The sintered object may exhibit a density larger than the density of the object prior to sintering, according to some embodiments. The object may be sintered without the melting of any build material powder, according to certain embodiments. The object may be sintered with the melting of only a portion of the build material powder, according to certain embodiments.

The process of sintering typically occurs in a sintering furnace, as will be appreciated by one skilled in the art. According to some embodiments, the sintering furnace may include a means of heating the object to be sintered. According to some embodiments, the sintering furnace may include a means of providing a flow of sintering process gas to the objects to be sintered, in such a way that the gaseous atmosphere around the objects to be sintered is at least partially controlled. According to some embodiments, the sintering furnace may include a means of controlling the pressure of a gaseous atmosphere around the objects during the sintering process (the “sintering pressure”). According to some embodiments, the means of controlling the pressure of a gaseous atmosphere around the objects during sintering may include a vacuum pump and at least one conduit to enable gaseous communication between a chamber housing the object to be sintered and the vacuum pump.

The gaseous atmosphere surrounding the object during sintering is often an important aspect of the sintering process. According to certain embodiments, the gaseous atmosphere may be comprised of hydrogen, helium, argon, nitrogen, carbon dioxide, carbon monoxide, methane, forming gas (a mixture of hydrogen and argon), ammonia, or air. According to certain embodiments, the gaseous atmosphere may be comprised of a mixture of gasses (95% nitrogen and 5% hydrogen by weight, for example). Careful selection of the gaseous atmosphere may promote certain mechanisms of sintering and lead to a desired amount of densification. As will be understood by one skilled in the art, the composition of the gaseous atmosphere surrounding the object during sintering may change during the sintering process, for example according to a predetermined schedule and in a coordinated fashion with the temperature, pressure, and flow rates as a function of time.

The pressure of the gaseous atmosphere surrounding the object during sintering is often an important aspect of the sintering process. According to certain embodiments, it is desirable to decrease the pressure in the sintering furnace to enhance the densification (that is, to increase the density) of an object undergoing sintering. According to certain embodiments, it is desirable to increase the pressure in the sintering furnace to enhance the densification (that is, to increase the density) of an object undergoing sintering. The selection of pressure is typically determined by the elements from which the build material powder is comprised in addition to the interaction of the elements with the gaseous atmosphere. In certain embodiments, the pressure of the gaseous atmosphere surrounding the object during sintering is at least 1 atmosphere and up to 5 atmospheres. In certain embodiments, the pressure of the gaseous atmosphere surrounding the object during sintering is at least 0.5 atmosphere and less than 1 atmosphere. In certain embodiments, the pressure of the gaseous atmosphere surrounding the object during sintering is at least 0.1 atmosphere and less than 0.5 atmosphere. In certain embodiments, the pressure of the gaseous atmosphere surrounding the object during sintering is at least 0.001 Torr atmosphere and less than 10 Torr. In certain embodiments, the pressure of the gaseous atmosphere surrounding the object during sintering is less than 0.001 Torr. As will be understood by one skilled in the art, the pressure of the gaseous atmosphere surrounding the object during sintering may change during the sintering process, for example according to a predetermined schedule and in a coordinated fashion with the temperature, composition, and flow rates as a function of time.

In some embodiments, the steps of debinding and sintering may occur during a sequentially or simultaneously in the same chamber, as part of a processing operation. For example, a single furnace may be used to first debind a part by controlling its temperature through starting and ending debind temperatures, and continuing to sintering temperatures without first cooling the part from the ending debind temperature.

### Build Material Powders

In certain embodiments, the build material may be any finely divided material or powder. The finely divided material may be a metal, oxide ceramic, non-oxide ceramic, glass, cermet, organic material, carbide, nitride, or any mixture, according to certain embodiments.

In certain embodiments, the build material may comprise a metallic powder. In certain embodiments, the metallic powder may comprise a pure element (such as elemental copper or iron). In certain embodiments, the metallic powder may comprise an alloy of metallic elements to form a specific grade of metal, such as 17-4 stainless steel, 316 stainless steel, 316L stainless steel, 4140 low alloy steel, Inconel 718, Inconel 625, 6061 aluminum, 7075 aluminum, Ti-6A1-4V titanium, F75 Co—Cr—Mo, or any other alloy capable of being produced in a powdered or finely-divided form. In certain embodiments, the metallic powder may comprise a mixture of powdered metallic elements purposed to achieve the desired chemical specification of an alloyed metal (for example, a mixture including elemental Co, Cr, and Mo powders to form an F75 alloy, or a mixture including Fe, Cr, V, C, Mn, Si, and Ni to form a stainless steel). In certain embodiments, the build material may comprise a metallic powder where the metal is a refractory metal (such as tungsten, tantalum, niobium, rhenium, molybdenum, hafnium, zirconium, or the like).

In certain embodiments, the build material may comprise a ceramic powder. In certain embodiments, the ceramic powder may comprise alumina, zirconia, yittria-stabilized zirconia, mullite, silica, chromia, spinel, and the like. In certain embodiments, the build material may be a mixture of ceramic powders (for example, silica and alumina, or magnesium oxide and alumina).

In certain embodiments, the build material may be naturally derived, as an organic material. In certain embodiments, the organic material may comprise a wood flour, sawdust, cellulosic fiber, or the like.

In certain embodiments, a binder jet printer may include a container to contain the build material powder and printed structures. The container may be indexable moveable relative to the build material delivery and spreading mechanisms, and may also be indexable relative to an inkjet head or heads which deposit the binding agent in a desired pattern to form a slice of a 3D structure on the surface of a powder bed. As may be appreciated by one skilled in the art, the ability of the binder jet printer to accurately position and index the bed is crucial to the performance of the binder jet printer, and, specifically, is crucial to the layer-to-layer tolerance of the objects (or parts) produced by the binder jet printer.

In the process of binder jetting additive manufacturing, a build material powder is delivered to and spread upon a build surface and a binding agent (or binder or ink) is deposited on the build material powder to at least partially bind the build material powder to form a slice of a 3D object. By repeating the steps of delivering a build material powder, spreading a build material powder, and depositing a binder corresponding to a desired image, a 3D structure may be formed. This process is understood to occur in a binder jetting printer (or binder jet printer).

The build material powder is central to the performance of the binder jet printing process. Specific attributes of the build material powder, in combination with certain aspects of the binder jet printer, in certain embodiments, will affect the process window (e.g., the freedom the operator of the binder jet printer may have to vary certain process parameters such as a print speed, a type of binder (or ink), a layer height, an atmosphere within the printer, among other attributes) in which the printer may produce objects of acceptable quality. In certain embodiments, it may be required to alter, condition, treat, or otherwise “cure” a build material powder to alter certain powder attributes.

A variety of powders may be used as build material powder. In certain embodiments, the build material may be any finely divided material or powder. The finely divided material may be a metal, oxide ceramic, non-oxide ceramic, glass, cermet, organic material, carbide, nitride, or any mixture, according to certain embodiments.

In certain embodiments, the build material may comprise a metallic powder. In certain embodiments, the metallic powder may comprise a pure element (such as elemental copper or iron). In certain embodiments, the metallic powder may comprise an alloy of metallic elements to form a specific grade of metal, such as 17-4 stainless steel, 316 stainless steel, 316L stainless steel, 4140 low alloy steel, Inconel 718, Inconel 625, 6061 aluminum, 7075 aluminum, Ti-6A1-4V titanium, F75 Co—Cr—Mo, or any other alloy capable of being produced in a powdered or finely-divided form. In certain embodiments, the metallic powder may comprise a mixture of powdered metallic elements purposed to achieve the desired chemical specification of an alloyed metal (for example, a mixture including elemental Co, Cr, and Mo powders to form an F75 alloy, or a mixture including Fe, Cr, V, C, Mn, Si, and Ni to form a stainless steel). In certain embodiments, the build material may comprise a metallic powder where the metal is a refractory metal (such as tungsten, tantalum, niobium, rhenium, molybdenum, hafnium, zirconium, or the like).

In certain embodiments, the build material may comprise a ceramic powder. In certain embodiments, the ceramic powder may comprise alumina, zirconia, yittria-stabilized zirconia, mullite, silica, chromia, spinel, and the like. In certain embodiments, the build material may be a mixture of ceramic powders (for example, silica and alumina, or magnesium oxide and alumina).

In certain embodiments, the build material may be naturally derived, as an organic material. In certain embodiments, the organic material may comprise a wood flour, sawdust, cellulosic fiber, or the like.

In certain embodiments, a curing process may be employed to vary the properties of a build material powder. In certain embodiments, the curing process may include such process features as (1) the application of heat to a build material powder, (2) the agitation of a build material powder, (3) the maintenance of a controlled atmosphere about the build material powder, (4) the flow and withdrawal of gases to an area (or volume) in which the build material powder is present, (5) the creation of a vacuum in a volume in which the build material powder is present, (6) the removal of heat (or cooling) of the build material powder, or other process features as described and disclosed herein.

In certain embodiments, the application of heat may be used to change a state of the build material powder. In certain embodiments, molecules, or any other matter may be stuck or adhered to the surface of the build material powder, and may affect the ability of the build material powder to flow, pack, compact, sinter, or interact with at least some aspect of the binder jet printing process. Changing a state of a build material powder may include changing the amount of moisture on the surface of the build material powder, in certain embodiments. For example, the build material powder may retain some amount of water vapor, bulk water, chemisorbed water, or any other type of moisture on the surface of the build material powder, In certain embodiments, the application of heat may result in, or at least assist in, the removal or decrease in (as compared to the build material powder prior to the application of heat) an amount of moisture present on the surface of the build material powder.

In certain embodiments, the surface of the build material powder may retain, be at least partially covered by, or otherwise be attached to organic molecules such as oils, waxes, alcohols, and the like. In certain embodiments, the application of heat may result in, or at least assist in, the removal or decrease in (as compared to the build material powder prior to the application of heat) an amount of organic molecules present on the surface of the build material powder.

In certain embodiments, the curing of build material powder may include the agitation of the build material powder. The agitation of the build powder may serve to mix the components of the build material powder. The agitation of the build material powder may be performed in concert with any other curing process feature such as heating, in certain embodiments. In certain embodiments including the agitation of the build material powder, and without being bound by theory, the agitation may physically affect the surface of the build material powder (perhaps by altering the surface roughness). In certain embodiments, the agitation of the build material powder may aid in the distribution of heat (when the powder, or any container in which the powder is contained, is heated or cooled). In certain embodiments, the agitation of the build material powder may aid in the removal of species (such as water, water vapor, oils, alcohols, other organics, and the like) from the surface of the build material powder by reasons that may include: aiding in the transport and mixing of the build material powder with the gaseous environment in the drum, and providing alternating exposure of the build material powder (via the agitation) to gaseous species with the drum.

In certain embodiments, the curing of the build material powder may include the control of the gaseous atmosphere about the build material powder. In certain embodiments, the build material powder may be exposed to a specific gaseous atmosphere. The gas atmosphere may be chosen to modify the surface of the build material powder by, for example, oxidation, carburizing, or nitriding. The specific gas atmosphere utilized may depend upon the build material powder.

In certain embodiments, the gaseous atmosphere to oxidize a powder may include or primarily consist of an oxidizing gas such as oxygen, air, water vapor, carbon monoxide, or carbon dioxide. In certain embodiments, for the case of iron-contain metals and alloys including, but not limited to, carbonyl iron, iron, carbon steels, midcarbon steels, tool steels, stainless steels, and the like, an oxidizing gas may be provided, optionally with an amount of heat or agitation to oxidize the build material powder and increase the amount of oxygen the powder. One skilled in the art will appreciate that a range of oxidizing gases and temperatures may be employed, and the range may dependent upon the composition of the alloy which is intended to be cured. In other embodiments, oxidation may be desired for other classes of materials including alloys of nickel, cobalt, chromium, titanium, aluminum, gold, silver, platinum, combinations of metals, or generally any alloy which may be employed for binder jet printing.

In certain embodiments, the gaseous atmosphere to nitride a powder may include or primarily consist of a nitriding gas such as ammonia or nitrogen. In certain embodiments, the gaseous atmosphere to carburize a powder may include or primarily consist of methane, acetylene, carbon monoxide, or carbon dioxide.

In certain embodiments, the curing of the build material powder may increase the oxygen content by between 10 and 1000 parts per million. In certain embodiments, the curing of the build material powder may increase the oxygen content by between 100 and 10,000 parts per million. In certain embodiments, the curing of the build material powder may increase the oxygen content by between 1,000 and 100,000 parts per million. In certain embodiments, the curing of the build material powder may negligibly affect the oxygen content of the build material powder, such that the oxygen content before and after curing is statistically insignificant.

In certain embodiments an inert gas may be used, such as argon or helium. In certain embodiments, nitrogen gas may be used, and may be considered inert for iron-based powders at temperatures less than 250 degrees centigrade.

In certain embodiments, the build material powder may be prohibited from contacting a specific gaseous atmosphere. In certain embodiments, a build material powder may be prevented from contacting oxygen or any oxygen containing gas, or oxygen above a pre-determined concentration. In some embodiments, the concentration of oxygen to which a build material powder is exposed may be controlled to be less than between 100 and 10,000 parts per million. In other embodiments, the concentration of oxygen to which a build material powder is exposed may be controlled to be less than 2 percent. In certain embodiments a build material powder may be prevented from contacting water vapor or any water vapor containing gas. One skilled in the art will appreciate that different alloys will exhibit different sensitivities and reactivities toward identical atmospheres.

In certain embodiments, a gaseous atmosphere may be substantially prevented from contacting build material powder, such as by providing a vacuum.

In certain embodiments, any combination of process features may be included to cure the build material powder. In certain embodiments, a first set of process features may be utilized to cure a build material powder in an initial state (the initial state may be the state the powder is received in from a supplier (a “virgin” powder), in certain embodiments), and a second set of process features may be utilized to cure a build material powder in a following state (the following state may be the state of the powder after it has been used in a binder jet printing process, in certain embodiments).

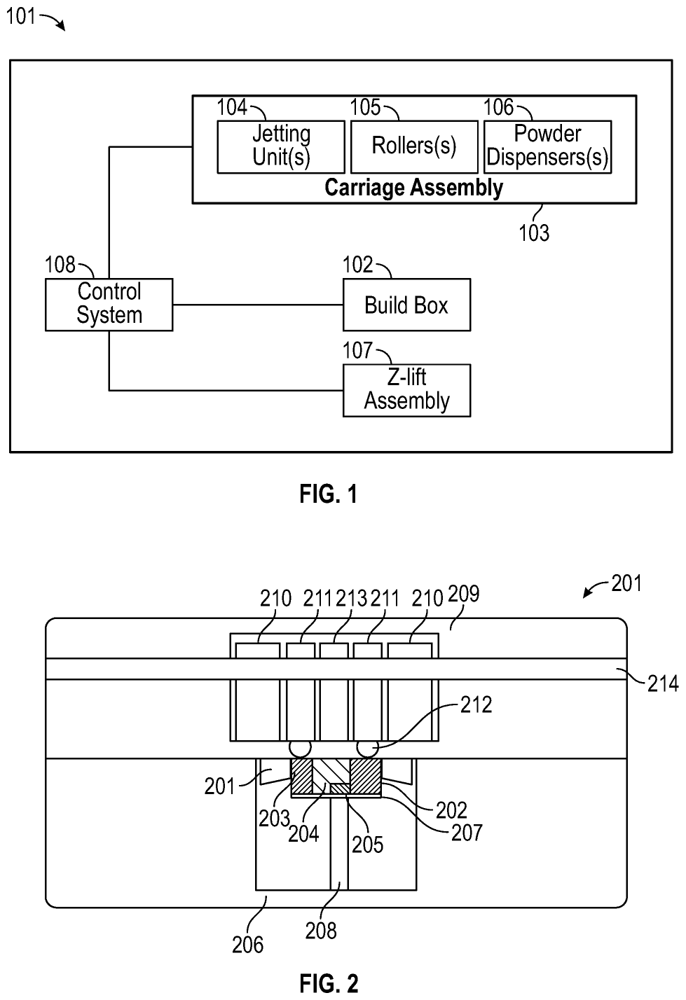

With reference to FIG. 1, a binder jetting printer 101 includes a build box 102 where a part is to be manufactured. A carriage assembly 103 is moved relative to the build box 102 to deposit successive layers of build material powder and binder to form parts. In certain embodiments, the binder jetting printer 101 can be used to manufacture metal parts. In these instances, the build material powder is metal powder, and the part is later sintered to densify the part. The carriage assembly includes jetting unit(s) 104 for depositing binder, roller(s) 105 for spreading powder layers prior to binder jetting and powder dispenser(s) 106 which meter build material powder for successively printed layers. In alternate embodiments, build material powder may be metered from elevators and spread across the build box. In the embodiment of FIG. 1, the printer 101 includes a lift assembly 107 which moves a build platen within the build box down as successive layers are printed. A control system 108 controls the various elements of the binder jetting printer 101.

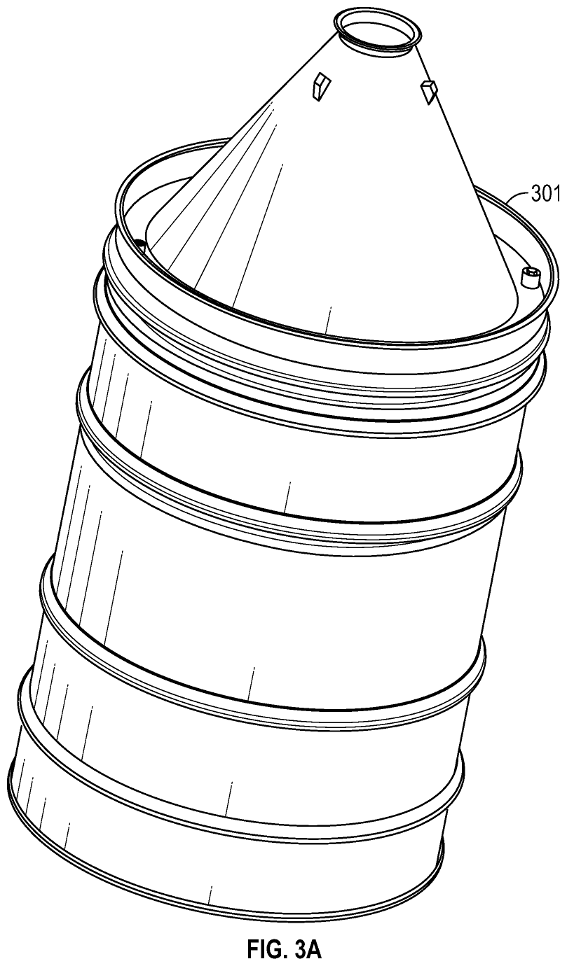

FIG. 2 depicts a side cutaway view of a binder jetting printer 201. A build box 202 contains loose powder 203 and a part 204 being manufactured and potentially support structures 205. A lift assembly 206 is configured to raise and lower the build box 202 and build platen 207 to facilitate the printing process. A lift 208 raises and lowers a build platen 207. A print carriage 209 traverses relative to the build box. In the depicted embodiment, the carriage 209 moves while the build box 202 is maintained in a static position, though the build box 202 could alternatively move while the carriage 209 is maintained in a static position. In the depicted embodiment, the carriage 209 includes an arrangement of components for use in jetting. In the embodiment, printing is bi-directional, i.e., in a first direction-left to right with reference to the figure, and then from right to left. To facilitate bi-directional printing, the depicted carriage 209 includes powder dispensing units 210, powder roller units 211 having rollers 212 and a jetting unit 213. The powder dispensing units 210 and powder roller units 211 alternate depending on the printing direction so that powder is dispensed ahead of the roller which distributes the powder before the single jetting unit 213 deposits binder. Rail system 214 facilitates the movement of print carriage 209.

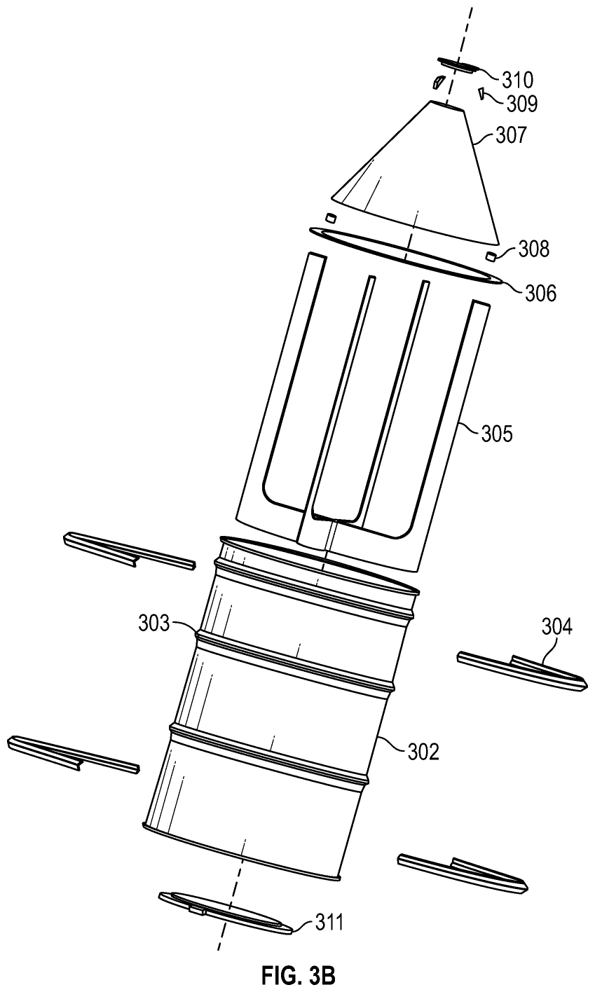

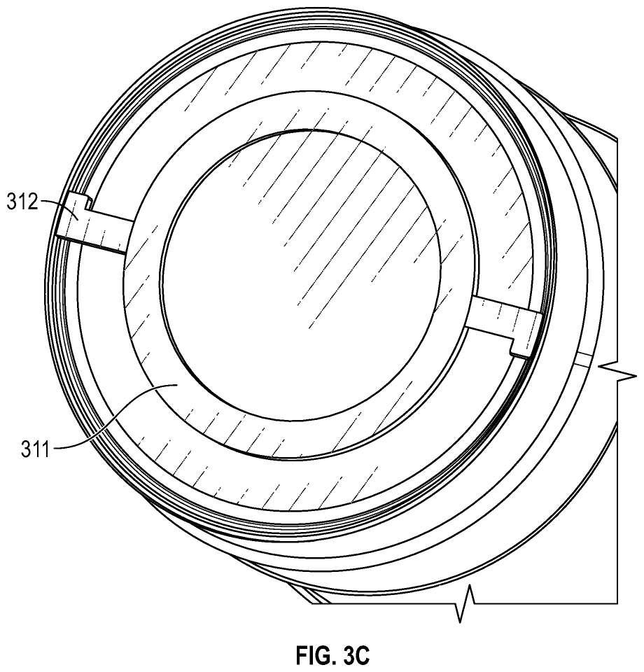

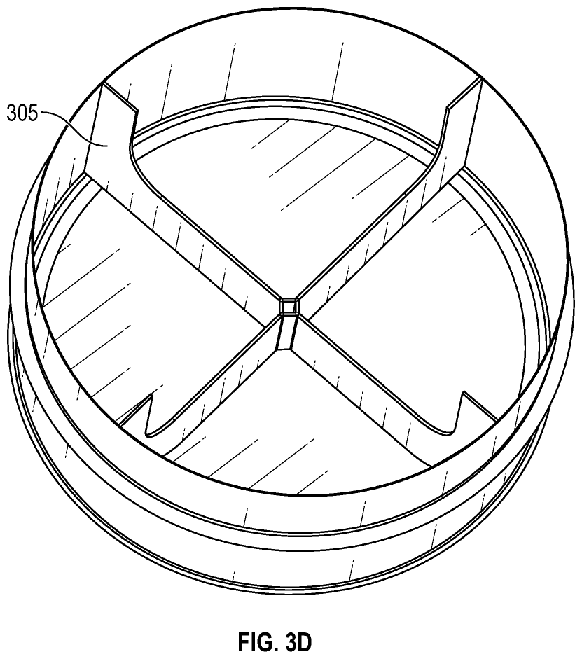

FIG. 3A depicts a perspective view of an embodiment drum 301. FIG. 3B depicts an exploded view of the drum 301. The drum 301 has a body 302, which may have strengthening protrusions 303. A plurality of circumferential rings 304 is affixed to the body 302. When the drum 301 is in a horizontal orientation (i.e., having a longitudinal axis parallel to ambient ground), the circumferential rings 304 are disposed to interact with a plurality of casters (not shown) and rotate in place. A plurality of internal baffles 305 provide increased rigidity to the drum 301 while also facilitating migration of build material powder when rotating the drum 301.

In some embodiments, internal baffles 305 may be designed to facilitate enhanced mixing of build material. Baffles 305 may be designed such that they extend from the internal wall of the drum by at least 5% of the inner diameter of the drum. In some embodiments, internal baffles may be further shaped to promote enhanced mixing, for example by being arranged in a helical pattern around the outside of the drum, or by having gaps, protrusions, perforations, or other features which may promote build material powder migration while rotating the drum. An annulus shaped rim 306 seals a first cap 307 to the body 302 of the drum 301. Gas ports 308 permit gas inflow or outflow from the drum 301. For example, during certain curing processes, a first gas port may be used as a gas inlet to provide a flow of process gas which may be inert gas such as nitrogen or argon, or may be another gas such as air or oxygen. Another gas port may be used as a gas outlet in conjunction or instead to remove a flow of used gas from the drum 301. Indexing tabs 309 are configured to interface with complementary features in mounts of units of a powder processing system, such as a curing station or dispensing station. A plug 310 is configured to hermetically seam the drum 301. A rotation plate 311 includes indentation profiles 312 (See FIG. 3C) configured to interface with a rotation mechanism in a curing station.

The drum may be constructed by means of butt-welding components, including the conical section, the bottom, and the cylindrical body of the drum. In some embodiments, the components may be produced by means of spin-forming. In some embodiments, the individual components may be polished prior to assembly and welding. In some embodiments, the bottom of the drum may be substantially flat (for example, a disk). In other embodiments, the bottom surface of the drum may be spherical or ellipsoidal, or any other suitable shape, which may be selected for ease of manufacturing, for ability to withstand internal drum pressures, and the like, as will be understood by one skilled in the art. Baffles 305 may be constructed of the same material as the body of the drum. All internal surfaces of the drum may be polished prior to welding of the drum.

In certain embodiments, the drum may be constructed to withstand a designed internal pressure (for example, a burst pressure). The design burst pressure may be selected based on a property of a build material powder to be stored or processed within a drum. For example, a Maximum Explosion Pressure (Pₘₐₓ) of a build material powder as defined by ASTM Standard E1226 may be selected as a design pressure. In some cases an additional factor of safety may be considered in the design. By designing to withstand a burst pressure, any explosion of build material powder may be contained to prevent damage to other equipment or harm to equipment operators.

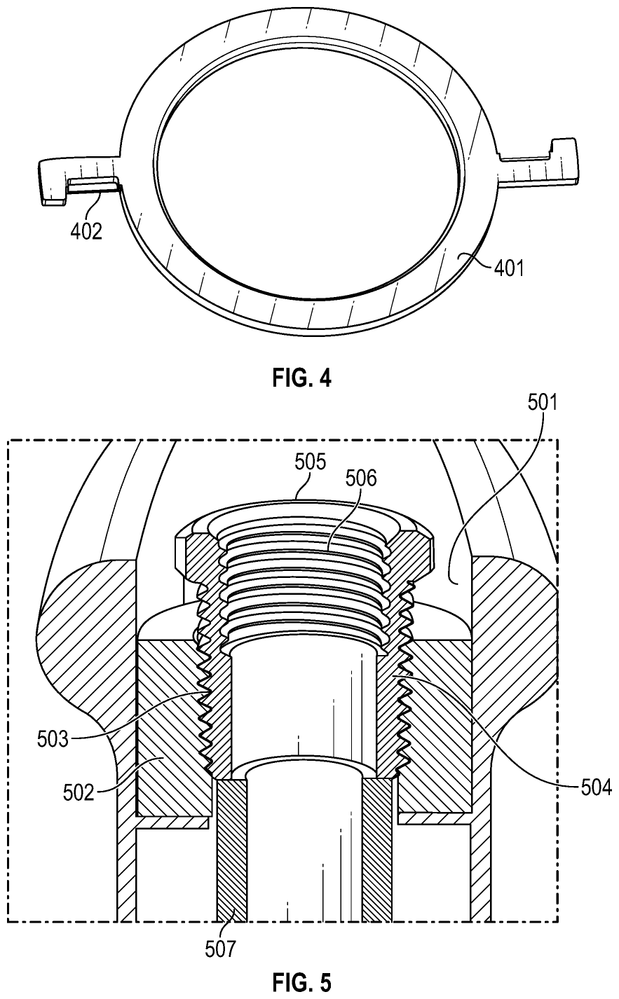

FIG. 4 depicts a second embodiment rotation plate 401 having indented tabs 402 configured to facilitate positive locking with a rotation mechanism.

With reference to FIG. 5, an embodiment gas port 501 includes a fitting 502 which may have a first threading 503 configured to receive a first threading 504 of an adapter 505 which may have a second threading 506 configured to receive a quick disconnect adapter. A gas tube 507 may transport gas into or out of a distal end of the drum.

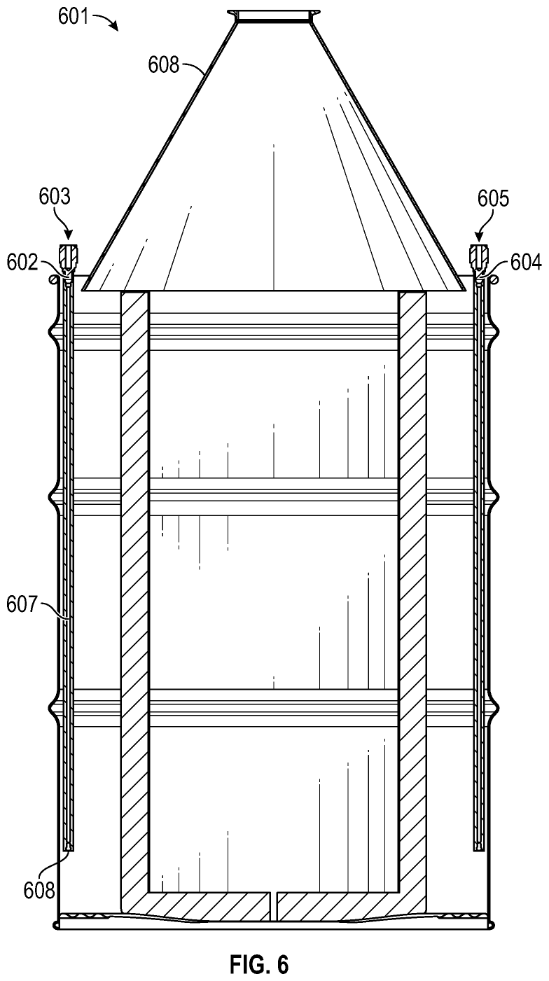

With reference to FIG. 6, a drum 601 includes a first gas port 602 having a first quick-disconnect adapter 603 and a second gas port 604 having a second quick disconnect adapter 605. Gas port 602 includes a gas tube 606 and a filter 607. The filter 507 may be sized to permit gas flow but prohibit build material powder from passing through the filter. For example, a filter pore size may be approximately 1-5 microns. The filter 507 is also selected for its ability to withstand high temperatures of curing. For example, the filter 507 may comprise a partially sintered metal matrix. The gas tube 606 conveys gas to a distal end of the drum 601. When a first cap 608 of the drum 601 is in a dispensing orientation to gravity feed build material, the gas tube 606 permits gas flow above a top of build material powder.

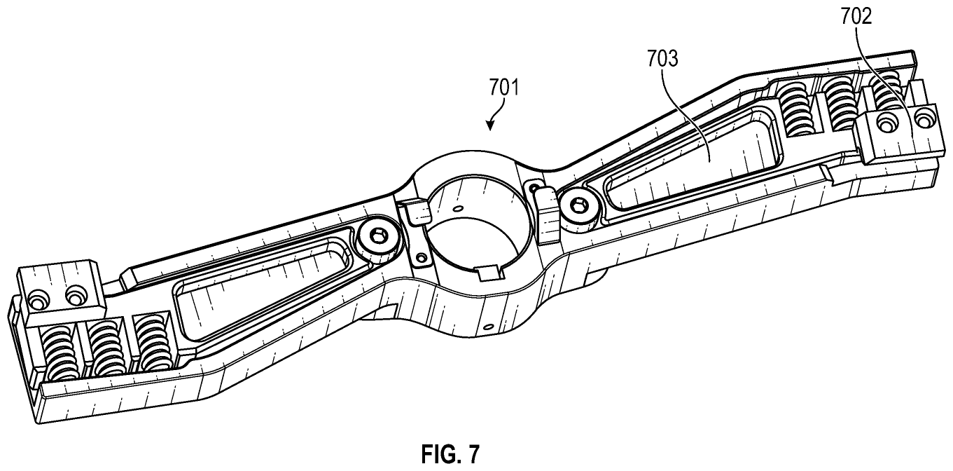

FIG. 7 depicts a rotation mechanism 701 having a pair of contact pads 702 on spring-biased engagement arms 703 configured to interface with indentation profiles of a rotation mechanism.

Now discussed are materials for manufacture of embodiment drums. In a first embodiment, the drum is manufactured from 304 Stainless Steel. Some or all of the surfaces of drum may be passivated per American Society for Testing and Materials (ATSM) Standard A967, or any other suitable passivation method, in order to prevent contamination oxidation, corrosion, contamination, or other interaction with build material powder. The external surfaces of the drum may be treated by CERAKOTE™ C-192 AMBIENT CURE CERAMIC COATING by NIC Industries, Inc. of White City, OR. The drum may alternatively be manufactured from 316 Stainless Steel, 409 Stainless Steel, 420 Stainless Steel and Aluminum. The internal surfaces of the drum may alternatively be treated with a functionalized silica-like CVD coating such as DURASAN® by Silcotek of Bellefonte, PA or a hydrogenated amorphous silicon CVD coating such as SILCOLLOY by Silcotek of Bellefonte, PA. The external surfaces of the drum may alternatively be treated with RUST-OLEUM™ 248903 HIGH TEMPERATURE AUTOMOTIVE PAINT (BLACK) by Rust-Oleum Corporation of Vernon Hills, IL or RUST-OLEUM™ 7778502 HEAT PROTECTIVE ENAMEL (BLACK) by Rust-Oleum Corporation of Vernon Hills, IL.

In some embodiments, the interior of the drum may be rinsed and dried or otherwise cleaned prior to the passivation or coating of the interior of the drum.

Other paints, coatings, or finished may be used for the exterior of drum, as will be understood by one of ordinary skill, such that they are disposed to be IR-absorbing, and resistant to wear and abrasion during drum handling, spinning, and the like.

What is claimed:

1. A drum for storing and processing build material powder, comprising:
a cylindrical body having a plurality of external circumferential rings and a plurality of internal baffles;
at a first end of the cylindrical body, a first cap tapered to an orifice;
at a second end of the cylindrical body, a second cap; and
a gas inlet configured to receive an inflow of an inert gas and a gas outlet configured to exhaust used gas from an interior of the drum.

2. The drum of claim 1 wherein the first cap is shaped as a conical frustum.

3. The drum of claim 1, wherein the second cap includes a rotation bar disposed on an exterior surface that is configured to interface with a rotation element of a curing station to rotate the drum around a longitudinal axis.

4. The drum of claim 1 wherein the gas inlet is connected to a tube configured to deliver the inert gas to an area proximate to the second end of the cylindrical body.

5. The drum of claim 1 wherein at least one of the gas inlet and the gas outlet are disposed through a rim between the cylindrical body and the first cap.

6. The drum of claim 1 wherein the opening of the first cap is defined by a rim configured to interface with an end cap and a powder interface.

7. The drum of claim 1 wherein an exterior of each of the cylindrical body, the first cap and the second cap are coated with a high-temperature paint pigmented to increase infrared heat transfer.

8. The drum of claim 1 wherein one or more of the plurality of internal baffles is an L-shaped plate.

9. The drum of claim 8 wherein a longitudinal width of the L-shaped plate is less than 25% of the mean diameter of the drum.

10. The drum of claim 1 wherein the circumferential rings are configured to interface with a plurality of caster units.

11. A drum for storing and processing build material powder, comprising:
a body including a plurality of features protruding from an exterior surface thereof and a plurality of internal baffles;
the body being sealed at each end by an end cap, at least one of the end caps having an orifice and a shape selected to facilitate gravity feed of the build material powder from the drum when the drum is in a dispensing orientation.

12. The drum of claim 11 wherein the orifice is configured to receive build material powder in a receiving orientation.

13. The drum of claim 11, further comprising a first gas interface and second gas interface, each providing a sealable gaseous connection between an interior of the body and an ambient environment.

14. The drum of claim 11 wherein the body has a constant cross-section profile along a longitudinal axis.

15. The drum of claim 11 wherein an exterior of each of the end caps are painted with a high-temperature paint pigmented to increase infrared heat transfer.

16. The drum of claim 11 wherein one or more of the plurality of internal baffles is an L-shaped plate.

17. The drum of claim 11 wherein a longitudinal surface of the L-shaped plate is sized to promote powder mixing during rotation of the drum about a longitudinal axis.

18. The drum of claim 11 wherein the plurality of features protruding from the exterior surface are circumferential rings.

19. The drum of claim 11 wherein the body is manufactured from a material selected from 316 Stainless Steel, 409 Stainless Steel, 420 Stainless Steel and Aluminum.
